(19) United States
(12) Patent Application Publication
(10) Pub. No.: US 2026/0061907 A1
(43) Pub. Date: Mar. 5, 2026

(54) CUSHION ASSEMBLY AND METHOD OF ASSEMBLY

(71) Applicant: Lear Corporation, Southfield, MI (US)

(72) Inventors: Joshua HALLOCK, Warren, MI (US); William PARUSZKIEWICZ, Clinton Township, MI (US); Lisa SWIKOSKI, West Bloomfield, MI (US); Mark KARGES, Macomb, MI (US); Thomas WELCH, JR., Ortonville, MI (US); Eric BRINES, White Lake, MI (US); Ronald MIOTTO, Canton, MI (US); Cory TYRRELL, Southfield, MI (US); Christopher D. JOHNSON, Novi, MI (US); Michelle BRUDZYNSKY, Farmington Hills, MI (US); Bradley DUNCAN, Harrison Township, MI (US); David HALE, Southfield, MI (US)

(21) Appl. No.: 19/301,278

(22) Filed: Aug. 15, 2025

Related U.S. Application Data
(60) Provisional application No. 63/687,857, filed on Aug. 28, 2024.

(51) Int. Cl. B60N 2/58

(52) U.S. Cl. CPC B60N 2/5891

(57) ABSTRACT

A cushion assembly is provided with a cushion, that is provided with a mesh member with a set of filaments of polymeric material that are looped and bonded to each other. A trim member is sized to extend at least partially across an occupant support surface of the cushion. A retainer is provided with a base connected to the trim member, a tether extending from the base and received in an aperture through the cushion. A flange is attached to the tether, spaced apart from the base, with a fastener is attached to the flange. Also, a flange provided with a portion that is elastically deformable relative to the tether so that the flange is collapsible and insertable through the aperture, and expandable to retain the retainer.

### TECHNICAL FIELD

Various embodiments relate to a cushion assembly and a method of assembly.

### BRIEF DESCRIPTION OF THE DRAWINGS

FIG. 1 is a perspective view of an example of a seat assembly including a filament mesh structure.

FIG. 2 is schematic view of an example of a manufacturing system for making the filament mesh structure.

FIG. 3 is a perspective view of a cushion assembly according to another embodiment.

FIG. 4 is a partial side section view of the cushion assembly of FIG. 3.

FIG. 5 is a perspective view of a cushion assembly according to another embodiment, illustrating an assembly step with a retainer.

FIG. 6 is a perspective view of the cushion assembly of FIG. 5 illustrating another assembly step.

FIG. 7 is a perspective view of the cushion assembly of FIG. 5 illustrating another assembly step.

FIG. 8 is a side elevation view of a retainer according to another embodiment.

FIG. 9 is a side elevation view of a retainer according to another embodiment.

FIG. 10 is a perspective view of a retainer according to another embodiment.

FIG. 11 is a side elevation view of the retainer of FIG. 10.

FIG. 12 is a perspective view of a retainer according to another embodiment.

FIG. 13 is a side elevation view of the retainer of FIG. 12.

FIG. 14 is a side elevation view of a retainer according to another embodiment.

FIG. 15 is a side elevation view of a retainer according to another embodiment.

FIG. 16 is a side elevation view of a retainer according to another embodiment.

FIG. 17 is a side elevation view of a retainer according to another embodiment.

FIG. 18 is a side elevation view of a retainer according to another embodiment.

FIG. 19 is a side elevation view of a retainer according to another embodiment.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It is to be understood that the disclosed embodiments are merely exemplary and that various and alternative forms are possible. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ embodiments according to the disclosure.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first retainer could be termed a second retainer, and, similarly, a second retainer could be termed a first retainer, without departing from the scope of the various described embodiments. The first retainer and the second retainer are both retainers, but they are not the same retainer.

The terminology used in the description of the various described embodiments herein is for the purpose of describing particular embodiments only and is not intended to be limiting. As used in the description of the various described embodiments and the appended claims, the singular forms “a” and “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including.” “comprises,” and/or “comprising” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting.” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

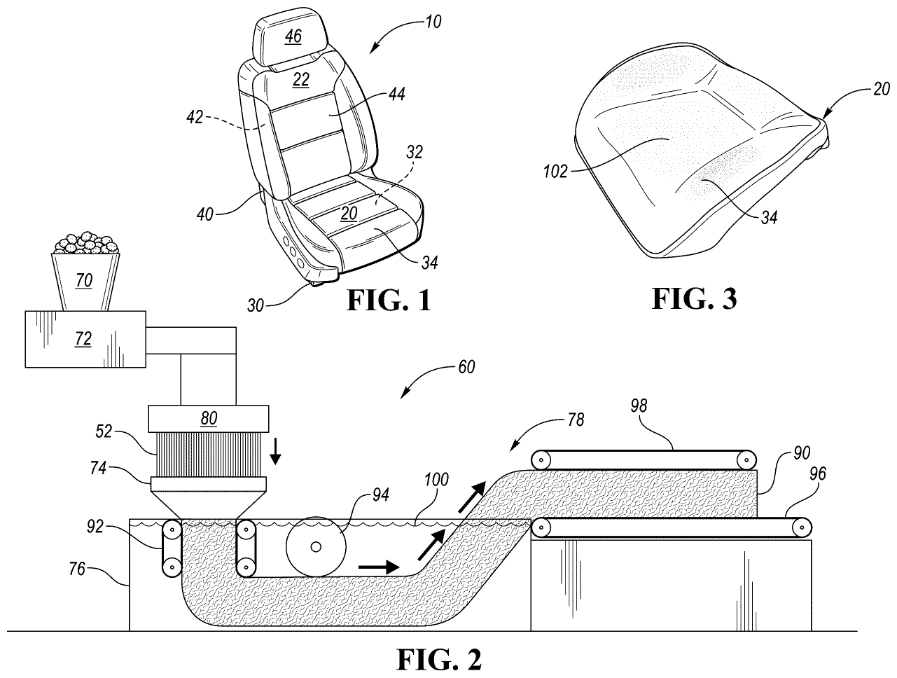

Referring to FIG. 1, an example of a seat assembly 10 is shown. In some embodiments, the seat assembly 10 is a vehicle seat assembly, such as for a land vehicle like a car, truck, bus, or the like, or for a non-land vehicle like aircraft or watercraft. For example, a seat assembly 10 for a land vehicle may be shaped and sized as a front row driver or passenger seat, a second, third, or other rear row seat, and may include bucket-style seats, bench-style seats, or other seat styles. Furthermore, the seat assembly 10 may be a non-stowable seat or a stowable seat that may be foldable and stowable in a cavity in the vehicle floor. Additionally, the seat assembly 10 may be configured for non-vehicle applications such as furniture.

In the configuration shown in FIG. 1, the seat assembly 10 includes a seat bottom 20 and a seat back 22. It is contemplated that the seat back 22 may be omitted in some configurations, such as when the seat assembly 10 is configured as a motorcycle seat or stool.

The seat bottom 20 is configured to receive a seated occupant and support the pelvis and thighs of the seat occupant. The seat bottom 20 includes a seat bottom frame 30, a cushion 32, and a trim cover 34.

The seat bottom frame 30 is a structure that supports the cushion 32. The seat bottom frame 30 includes one or more structural members and may be made of any suitable material, such as a metal alloy, polymeric material, fiber reinforced polymeric material, or combinations thereof. In some configurations, the seat bottom frame 30 includes a panel, seat pan, suspension mat, or suspension wires upon which the cushion 32 is disposed.

The cushion 32 is disposed on the seat bottom frame 30. The cushion 32 is made of a compliant material that supports the seat occupant and distributes load forces from the seat occupant to the seat bottom frame 30. The cushion 32 and associated methods of manufacture will be discussed in more detail below.

The trim cover 34 covers at least a portion of the cushion 32. In addition, the trim cover 34 provides one or more visible exterior surfaces of the seat back 22. The seat occupant may be disposed on the trim cover 34 when seated upon the seat assembly 10. The trim cover 34 is made of any suitable material or materials, such as fabric, leather, leatherette, vinyl, or combinations thereof. The trim cover 34 may include a plurality of trim panels that are assembled in any suitable manner, such as by fusing or stitching. The trim cover 34 is attached to the seat bottom frame 30, the cushion 32, or both. For example, the trim cover 34 may include trim attachment features that are attached to the seat bottom frame 30, the cushion 32, or both, to inhibit removal of the trim cover 34 and help conform the trim cover 34 to the contour of the seat bottom frame 30, the cushion 32, or both. The trim cover 34 may also be attached to an attachment pad as will be discussed in more detail below.

The seat back 22 is configured to support the back of a seated occupant. The seat back 22 is disposed adjacent to the seat bottom 20. For example, the seat back 22 may be disposed above the seat bottom 20 and near the rear side of the seat bottom 20. The seat back 22 extends in a generally upward direction away from the seat bottom 20. In some configurations, the seat back 22 is mounted to the seat bottom 20 and may be pivotable with respect to the seat bottom 20. In other configurations, the seat back 22 is not mounted to the seat bottom 20. For instance, a vehicle seat back may be mounted to the vehicle body structure, such as in some second row seat assemblies. The seat back 22 includes a seat back frame 40, a cushion 42, a trim cover 44, and optionally a head restraint 46.

The seat back frame 40 is a structure that supports the cushion 42. The seat back frame 40 includes one or more structural members and may be made of any suitable material, such as a metal alloy, polymeric material, fiber reinforced polymeric material, or combinations thereof. In some configurations, the seat back frame 40 includes a panel, pan, suspension mat, or suspension wires upon which the cushion 42 is disposed. It is also contemplated that the seat back frame 40 may be integrally formed with the seat bottom frame 30 in some configurations.

The cushion 42 is disposed on the seat back frame 40. The cushion 42 is made of a compliant material that supports the seat occupant and distributes load forces from the seat occupant to the seat back frame 40. It is contemplated that the cushion 42 may be integrally formed with the cushion 32 of the seat bottom 20 or may be separate from the cushion 32 of the seat bottom 20. The cushion 42 and associated methods of manufacture will be discussed in more detail below.

The trim cover 44 covers at least a portion of the cushion 42. In addition, the trim cover 44 provides one or more visible exterior surfaces of the seat back 22. The seat occupant may be disposed on the trim cover 44 when seated upon the seat assembly 10. The trim cover 44 is made of any suitable material or materials, such as fabric, leather, leatherette, vinyl, or combinations thereof. The trim cover 44 may include one trim panel or a plurality of trim panels that are assembled in any suitable manner, such as by fusing or stitching. The trim cover 44 is attached to the seat back frame 40, the cushion 42, or both. For example, the trim cover 44 may include trim attachment features that are attached to the seat back frame 40, the cushion 42, or both, to inhibit removal of the trim cover 44 and help conform the trim cover 44 to the contour of the seat back frame 40, the cushion 42, or both. The trim cover 44 may also be attached to an attachment pad as will be discussed in more detail below.

The head restraint 46, if provided, is configured to support the head of a seat occupant. The head restraint 46 is disposed at the top of the seat back 22 or at an end of the seat back 22 that is disposed opposite the seat bottom 20. The head restraint 46 may be moveable in one or more directions with respect to the seat back 22 or may be integrally formed with the seat back 22.

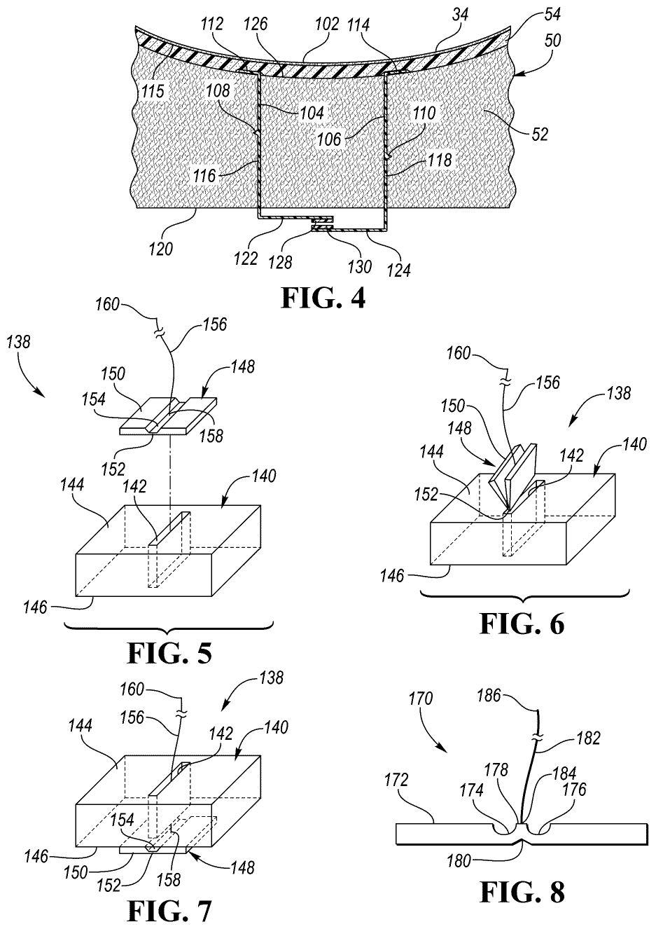

Referring to FIG. 4, an example of a cushion 50 is shown. The cushion in generically designated with reference number 50 for convenience in reference. It is to be understood that the structure and description of the cushion 50 is applicable to the cushion 32 of the seat bottom 20, the cushion 42 of the seat back 22, or both.

The cushion 50 is a non-foam component or includes at least one non-foam component.

The non-foam component is primarily referred to as a mesh member but may also be referred to as a stranded member, looped member, entangled member, filament mesh structure, mesh structure, stranded mesh, looped mesh, entangled mesh, or mesh cushion. In FIG. 4, the cushion 50 is depicted as a non-foam component that does not include a foam component or foam material, such as urethane or polyurethane foam; however, it is contemplated that the cushion 50 may also include a foam component or foam material in addition to a non-foam component to provide additional cushioning or localized cushioning for a seat occupant. For example, foam material 54 may be provided between the cushion 50 and a trim cover (e.g., trim cover 34, 44) that is disposed on the cushion 50, within the cushion 50, or combinations thereof. Reducing the amount of foam material that is provided with the cushion 50 or eliminating foam material from the cushion 50 reduces weight and may improve support and comfort of a seat occupant. In addition, eliminating foam material may facilitate recycling of the cushion 50.

The cushion 50 is described below in the context of a cushion 50 that does not include foam material. In this context, the cushion 50 is made of filaments 52 of polymeric material that are randomly looped, bent, curled, or entangled and are bonded together as will be discussed in more detail below. A filament 52 is directly bonded to another filament 52 rather than being indirectly bonded with a resin or other intermediate material.

The filaments 52, which may also be referred to as strands or threads, are made of any suitable material or materials. In some configurations, the filaments 52 are made of a polymeric material or thermoplastic material, such as a thermoplastic resin that is polyamide-based, polyester-based, polyimide-based, polyolefin-based (e.g., polypropylene-based, polyethylene-based, etc.), polystyrene-based, or combinations thereof. As one example, a polyethylene-based filament may be made of linear low density polyethylene (LLPDE). The filament material may be recyclable unlike foam material or more easily recycled than foam material. It is also contemplated that a filament 52 may comprise reinforcement fibers and that the reinforcement fibers may not be made of a thermoplastic material.

In some configurations, a filament 52 may be a monofilament that is made of a single material. In some configurations, a filament 52 is made of multiple materials. As an example, a filament 52 made of multiple materials may include a core that is made of a first thermoplastic material and a sheath that encircles the core and is made of a second thermoplastic material that differs from the first thermoplastic material. It is contemplated that the cushion 50 may include a combination of monofilaments and filaments that are made of multiple materials and are not monofilaments.

Filaments 52 that are randomly looped, bent, looped, curled, or entangled are bonded together where one filament 52 contacts another filament 52, thereby resulting in a lightweight, air permeable cushion (e.g., cushion 32 and/or 42) or mesh structure having openings or voids between the filaments 52. An example of a manufacturing system 60 for making a cushion 50 or filament mesh structure 50 is also shown in FIG. 2. In this example, the manufacturing system 60 includes a material supply 70, an extruder 72, and a funnel 74. The manufacturing system 60 also includes a cooling tank 76 and a material handling subsystem 78.

Referring to FIG. 2, the material supply 70 holds material stock that is to be extruded, such as solid beads, flakes, granules, pellets, or powder made of the material. In some configurations, the material supply 70 is configured as a container or hopper. The material supply 70 provides material stock to the extruder 72.

The extruder 72 melts the material stock and extrudes the material stock into a set of filaments 52. The extruder 72 may have any suitable configuration. In some configurations, the extruder 72 includes a barrel that receives a rotatable screw and heating elements. Rotation of the screw forces the material to move through the barrel and helps heat the material due to the friction generated as the screw rotates. The material exits the barrel under pressure and in a molten state and is transported under pressure to a die 80 of the extruder 72.

The die 80, which may also be referred to as a die plate or extrusion die, has multiple through holes or filament forming openings through which the molten material passes. A single filament 52 is extruded from each through hole. The filaments 52 fall downward from the die 80 under the force of gravity into the funnel 74.

The funnel 74 consolidates or groups the filaments 52 into a more compact arrangement in which the filaments 52 bend, curl, or loop and a filament 52 contacts and bonds to at least one other filament 52. The funnel 74 has an inlet opening or funnel inlet and an outlet opening or funnel outlet that is smaller than the funnel inlet. Individual separated filaments 52 enter the funnel inlet. The filaments 52 bend, curl, or loop and move into contact as they accumulate. The filaments 52 move through the funnel 74 toward the funnel outlet. Some filaments 52 may slide along the funnel 74 or an intervening sheet that is disposed on the funnel 74 as the filaments move toward the funnel outlet. Bonds are formed between filaments 52 at the points of contact while openings or voids between filaments 52 are present at other locations where one filament 52 does not contact or bond to another filament 52. The entangled and bonded filaments 52 pass through the funnel outlet of the funnel 74 and enter the cooling tank 76. For convenience in reference, the bonded filaments 52 are referred to as a mesh member or filament mesh structure 90.

The cooling tank 76 holds a liquid 100, such as water or a mixture of water and another fluid. The liquid 100 in the cooling tank 76 helps support the entangled and bonded filaments 52 to limit further compacting or consolidation of the filaments 52 into a less open or less porous arrangement and maintains a desired porosity and density of the filament mesh structure 90. Thus, the liquid 100 provides some buoyancy or resistance that can result in additional bending, curling, or looping of the filaments 52 adjacent to the surface of the liquid 100 or within the funnel 74 to further build the filament mesh structure 90. The liquid 100 also cools the filaments 52 when the filaments 52 are in the liquid 100. For instance, the liquid 100 cools the filaments 52 from the outside to solidify the filaments 52 and prevent the filaments 52 from bonding at additional locations. At this point, the filaments 52 are relatively stiff and no longer in a plastic state and thus generally maintain a shape and are not moldable or reformable without being reheated.

The material handling subsystem 78 transports the filament mesh structure 90 through the cooling tank 76. The material handling subsystem 78 includes various rollers and conveyors that help move the filament mesh structure 90 through the liquid 100 and out of the liquid 100. In some configurations, a tractor conveyor 92 is provided in the cooling tank 76 to help pull the filament mesh structure 90 away from the funnel 74 and to counter buoyancy of the filaments 52.

One or more other rollers, such as roller 94, keep the filament mesh structure 90 submerged in the liquid 100 and guide the filament mesh structure 90 through the cooling tank 76. For example, the roller 94 may guide the filament mesh structure 90 toward a conveyor belt 96 and shaker table 98 that are disposed outside of the cooling tank 76. The shaker table 98 shakes the filament mesh structure 90 while it is on the conveyor belt 96 to remove liquid. Alternatively, or in addition, the filament mesh structure 90 may be squeezed to remove liquid, air may be blown toward the filament mesh structure 90 to help remove liquid from the filament mesh structure 90, or both. It is also contemplated that the filament mesh structure 90 may also be allowed to drip dry, or dry in ambient air.

The manufacturing system 60 described above is a continuous flow process in which the filament mesh structure 90 is formed as a continuous structure when filament extrusion is not interrupted. Further processing of the filament mesh structure 90 is provided after exiting the cooling tank 76 to cut the filament mesh structure 90 into individual pieces or blanks for individual cushions 50. Such processing is conducted by a cutting subsystem of the manufacturing system 60. The cutting subsystem may be of any suitable type. For instance, the cutting subsystem may employ a blade, knife, hot knife, saw, fluid jet, or the like to cut the filaments 52 of the filament mesh structure 90 into a blank. The cutting subsystem may be used to shape or contour the blank. It is also contemplated that a blank may be further shaped or contoured with other manufacturing processes, such as molding of the entire blank or a portion thereof.

With the above process, the cushion 50 may be formed of a set of filaments 52, wherein at least two members of the set of filaments 52 are looped and bonded to each other. In one or more embodiments, each member of the set of filaments 52 is looped and bonded to at least one other member of the set of filaments 52.

FIGS. 3 and 4 illustrate the seat bottom 20 according to another embodiment. The seat bottom 20 includes an occupant support surface 102 provided upon the trim cover 34 that is sized and contoured to receive and support an occupant. The trim cover 34 is attached to the cushion 50 without seams through the occupant support surface 102. As illustrated in FIG. 4, at least one or more apertures 104, 106 is formed through the cushion 50. The apertures 104, 106 are spaced apart from each other. A pair of retainers 108, 110 is connected to the trim cover 34 to attach the trim cover 34 to the cushion 50.

The retainers 108, 110 may be bellyband material strips, elastic strips, nonwoven fabric, Duon® from Propex Operating Company, LLC of 4019 Industry Drive, Chattanooga, Tennessee, 37416, US, a trim layer material, a barrier layer material, fabric, leather, polymeric material, such as thermoplastic polyurethane (TPU) film, polyvinyl chloride (PVC) film, polyethylene, or any suitable material. The retainers 108, 110 each include a base 112, 114. The bases 112, 114 are attached to an underside of the foundation layer 54. The foundation layer 54 may be a foam layer 54 or the like that is laminated to an underside, or concealed B-surface 115, of the trim cover 34. The bases 112, 114 can be sewn, blind stitched, laminated, glued, welded, or otherwise attached to the foundation layer 54. Alternatively, the bases 112, 114 can be attached directly to the trim cover 34.

The retainers 108, 110 are flexible and each include a tether portion 116, 118 extending from the bases 112, 114. The tethers 116, 118 are angled relative to the bases 112, 114. The tethers 116, 118 are sized to be received in the apertures 104, 106 respectively. The tethers 116, 118 extend through the apertures 104, 106 to a rear surface 120 or B-surface of the cushion 50. Alternatively, the tethers 116, 118 may extend to a channel 120, slot or other recessed support surface within the cushion 50. The retainers 108, 110 each include a flange 122, 124 extending from the corresponding tether 116, 118. The flanges 122, 124 are sized to collectively extend beyond and overlap midway between the spacing of the apertures 104, 106 on the rear surface 120 of the cushion 50. The flanges 122, 124 are sized to be inserted through the apertures 104, 106 from a front surface 126 or A-surface 126, through the cushion 50, and beyond the rear surface 120.

A pair of fasteners 128, 130 are each attached to one of the flanges 122, 124. The fasteners 128, 130 are oriented to engage each other when the flanges 122, 124 are overlapped. The fasteners 128, 130 may each be one of a hook and loop fastener 128, 130 to fasten to each other upon contact. Other suitable fasteners 128, 130 may include friction fasteners, interference fasteners, clips, or the like. Each fastener 128, 130 is sized to pass through the corresponding aperture 104, 106 with the associated flange 122, 124. Alternatively, the fasteners 128, 130 may be attached to the flanges 122, 124 after the flanges 122, 124 are inserted through the apertures 104, 106.

Referring again to FIGS. 3 and 4, the retainers 108, 110 attach and retain the trim cover 34 within the occupant support surface 102 of the cushion without providing an externally visible join within the support surface 102. The retainers 108, 110 provide attachment while eliminating externally visible seams, stitching, welds, tie-downs, or other visible joins and appearances formed from such retainers. According to yet another embodiment, the cushion 50 may be formed from foam.

FIGS. 5-7 illustrate a cushion assembly 138 according to another embodiment, which includes a cushion 140. The cushion 140 may utilize the cushion 50 for the seat bottom cushion 32 or the seat back cushion 42 according to some embodiments. The cushion 140 may be formed according to the processes described with reference to cushions 32, 42, 50. The cushion 140 has an aperture 142 formed therethrough. For example, the cushion 140 has a body defining a forward surface 144 which faces the trim cover 34 and engages the trim cover 34 or an intermediate lamination layer 54 of the trim cover 34. The forward surface 144 provides an occupant support surface 144. The aperture 142 is formed through the forward surface 144 and through a rearward surface 146 of the cushion 140.

With continued reference to FIGS. 5-7, the cushion assembly 138 also includes a retainer 148 for attaching the trim cover 34 to the cushion 140. The retainer 148 includes a flange 150 formed from an extruded polymeric material. The flange 150 may also be formed from a bellyband material strip, an elastic strip, a nonwoven fabric, Duon®, a trim layer material, a barrier layer material, a fabric, leather, a polymeric material, such as thermoplastic polyurethane (TPU) film, a polyvinyl chloride (PVC) film, polyethylene, cardboard, an extrusion, or any suitable material. The flange 150 may be referred to as a paddle 150.

The flange 150 has a length and a thickness. The flange 150 is elastically deformable along its length. The elastic deformability of the flange 150 may be provided by a weakened portion 152. The flange 150 may include a recess 154 formed into the thickness of the flange 150 to reduce the thickness at the weakened portion 152. The flange 150 is designed with the weakened region 152 to determine the region for elastic deformation and to act as a living hinge for the flange 150.

The retainer 148 includes a tether 156 attached to the flange 150. The tether 156 may be formed integrally with the flange 150. In some embodiments, the tether 156 is formed from a bellyband material strip, an elastic strip, a nonwoven fabric, Duon®, a trim layer material, a barrier layer material, fabric, leather, polymeric material, such as thermoplastic polyurethane (TPU) film, polyvinyl chloride (PVC) film, polyethylene, cardboard, an extrusion, a thread, a filament, or any suitable material. The tether 156 may be tied, sewn, welded, stitched, blind-stitched, or otherwise fastened to the flange 150. A proximal end 158 of the tether 156 is attached to the flange 150 at the weakened section 152 within the recess 154. A distal end 160 of the tether 156 is attachable to the trim cover 34 directly, or indirectly via an intermediate foundation layer 54 as demonstrated in prior embodiments. The distal end 160 may be attached directly or may employ a base for the attachments, as in the prior embodiments. The tether 156 is utilized to interconnect the trim cover 34 and the flange 150, while permitting the flange 150 to be spaced apart from the trim cover 34. The tether 156 is sized to be received through the aperture 142.

With reference to FIG. 5, the flange 150 is illustrated in an expanded position. From FIG. 5 to FIG. 6, the flange 150 is elastically deformed, or folded at the weakened region 152 such that terminal ends of the flange 150 converge, thereby collapsing the flange 150 to a collapsed position illustrated in FIG. 6. In the collapsed position of the flange 150, the flange 150 is sized to pass through the aperture 142. In FIG. 6, the flange 150 is collapsed, and is also inserted into the aperture 142. After the flange 150 is inserted through the aperture 142 from FIG. 6 to FIG. 7, the flange 150 expands to elastically return to the expanded position, which provides a retention position to engage the second surface 146 and retain the trim cover 34 to the cushion 140. The expanded flange 150 strengthens a hold of the trim cover 34 when the flange 150 is in the expanded position. The elastic deformation of the flange 150 permits the flange 150 to return to the expanded position, when unloaded, to hold the shape of the flange 150 to support the tether 156 when a tension load is applied to the tether 156.

In contrast to prior paddles that are not folded, the retainer 148 reduces assembly time by providing compactness, and an case in insertion and installation. The retainer 148 also avoids: rotation, insertion, and straightening, as associated with a full-length paddle. The case in installation is provided by the compact collapsed size. Further case is provided in that it is more ergonomic to insert a folded flange 150 than a full length, rotated paddle. In other words, it is easier to force an arrow than push an askew paddle with a flexible tether. The retainer 148 also permits attachment of the trim cover 34 to the cushion 140 as a tic-down, without a visible or apparent join, such as a scam, stitching, weld line, or the like.

FIG. 8 illustrates a retainer 170 according to another embodiment for utilization with the cushion 140 of the prior embodiment. The retainer 170 includes a flange 172, which may be formed from an extruded polymeric material. The flange 172 may also be formed from a bellyband material strip, an elastic strip, a nonwoven fabric, Duon®, a trim layer material, a barrier layer material, fabric, leather, a polymeric material, such as thermoplastic polyurethane (TPU) film, a polyvinyl chloride (PVC) film, polyethylene, cardboard, an extrusion, or any suitable material.

The flange 172 has a length and a thickness. The flange 172 is elastically deformable along its length. The elastic deformability of the flange 172 is provided by a pair of weakened portions 174. The flange 172 includes a pair of curved recesses 176 formed into the thickness of the flange 172 to reduce the thickness at the weakened portions 174. The curved recesses 176 may be C-shaped or scallop-shaped. The flange 172 is designed with the weakened regions 174 to define the regions for elastic deformation and to act as a living hinge for the flange 172. The pair of curved recesses 176 provide a post 178 formed between the recesses 176. Another recess 180 is formed in the flange 172 in a surface spaced apart from the curved recesses 176 and the post 178. The recess 180 is formed as a notch 180 or a V-shaped groove 180 and is formed centrally and aligned with the post 178. The notch 180 further reduces material thickness of the weakened regions 174, and provides a relief to avoid plastic deformation of the flange 172.

The retainer 170 includes a tether 182 attached to the post 178 of the flange 172. The tether 182 may be formed integrally with the flange 172. In some embodiments, the tether 182 is formed from a bellyband material strip, an elastic strip, a nonwoven fabric, Duon®, a trim layer material, a barrier layer material, fabric, leather, polymeric material, such as thermoplastic polyurethane (TPU) film, polyvinyl chloride (PVC) film, polyethylene, cardboard, an extrusion, a thread, a filament, or any suitable material. The tether 182 may be tied, sewn, welded, stitched, blind-stitched, or otherwise fastened to the flange 172. A proximal end 184 of the tether 182 is attached to the flange 172 at the post 178 between the curved recesses 176. A distal end 186 of the tether 182 is attachable to the trim cover 34 directly, or indirectly via an intermediate foundation layer 54 as demonstrated in prior embodiments. The distal end 186 may be attached directly or may employ a base for the attachments, as in the prior embodiments. The tether 182 is utilized to interconnect the trim cover 34 and the flange 172, while permitting the flange 172 to be spaced apart from the trim cover 34. The tether 182 is sized to be received through the aperture 142 of the cushion 140.

The flange 172 is illustrated in an expanded position. For installation, the flange 172 is elastically deformed, or folded at the weakened regions 174 such that terminal ends of the flange 172 converge, thereby collapsing the flange 172 to a collapsed position. In the collapsed position of the flange 172, the flange 172 is sized to pass through the aperture 142. After the flange 172 is inserted through the aperture 142, the flange 172 expands to elastically return to the expanded position, which provides a retention position to engage the second surface 146 and retain the trim cover 34 to the cushion 140.

In contrast to prior paddles that are not folded, the retainer 170 reduces assembly time by providing compactness, and an ease in insertion and installation. The retainer 170 also avoids: rotation, insertion, and straightening, as associated with a full-length paddle. The ease in installation is provided by the compact collapsed size. Further ease is provided in that it is more ergonomic to insert a folded flange 172 than a full length, rotated paddle. In other words, it is easier to force an arrow than push an askew paddle with a flexible tether. The retainer 170 also permits attachment of the trim cover 34 to the cushion 140 as a tie-down, without a visible or apparent join, such as a seam, stitching, weld line, or the like.

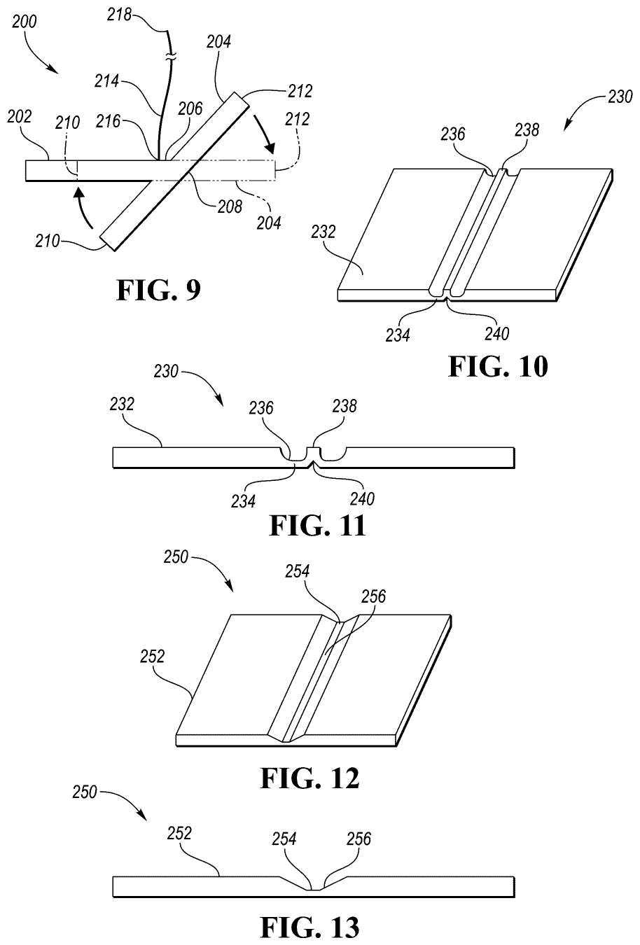

FIG. 9 illustrates a retainer 200 according to another embodiment for utilization with the cushion 140 of the prior embodiments. The retainer 200 includes a first flange 202, which may be formed from an extruded polymeric material. The first flange 202 may also be formed from a bellyband material strip, an elastic strip, a nonwoven fabric, Duon®, a trim layer material, a barrier layer material, fabric, leather, a polymeric material, such as thermoplastic polyurethane (TPU) film, a polyvinyl chloride (PVC) film, polyethylene, cardboard, an extrusion, or any suitable material.

The first flange 202 has a length and a thickness. The retainer 200 also has a second flange 204. The second flange 204 may be formed integrally with the first flange 202. The second flange 204 also has a length and a thickness. The second flange 204 is connected to a proximal end 206 of the first flange 202 at a midpoint 208 of the second flange 204. The length of the second flange 204 provides a pair of spaced apart terminal ends 210, 212 that extend away from the first flange proximal end 206. The second flange 204 is angled relative to the first flange 202 to provide an acute angle between the first flange 202 and the second flange terminal end 210, while providing an obtuse angle between the first flange 202 and the second flange terminal end 212.

The second flange 204 is elastically deformable relative to the first flange 202. The clastic deformability of the second flange 204 may be permitted by material characteristics of the integral retainer flanges 202, 204. Further, the relative elastic deformability may be provided by a reduced material in the second flange 204 relative to the first flange 202, such as a narrower thickness or narrower depth. Alternatively, the relative clastic deformability of the second flange 204 relative to the first flange 202 may be provided by variations of material characteristics, such as a stiffer durometer of the first flange 202 relative to the second flange 204. As illustrated by the arrows and phantom lines in FIG. 9, the second flange 204 can be pivoted to collapse in line with the first flange 202.

The retainer 200 includes a tether 214 attached to the first flange 202 near the first flange proximal end 206. The tether 214 may be formed integrally with the first flange 202. In some embodiments, the tether 214 is formed from a bellyband material strip, an elastic strip, a nonwoven fabric, Duon®, a trim layer material, a barrier layer material, fabric, leather, polymeric material, such as thermoplastic polyurethane (TPU) film, polyvinyl chloride (PVC) film, polyethylene, cardboard, an extrusion, a thread, a filament, or any suitable material. The tether 214 may be tied, sewn, welded, stitched, blind-stitched, or otherwise fastened to the first flange 202.

A proximal end 216 of the tether 214 is attached to the first flange 202 adjacent the first flange proximal end 206. A distal end 218 of the tether 214 is attachable to the trim cover 34 directly, or indirectly via an intermediate foundation layer 54 as demonstrated in prior embodiments. The distal end 218 may be attached directly or may employ a base for the attachments, as in the prior embodiments. The tether 214 is utilized to interconnect the trim cover 34 and the first flange 202, while permitting the first flange 202 to be spaced apart from the trim cover 34. The tether 214 is sized to be received through the aperture 142 of the cushion 140.

The first flange 202 and the second flange 204 are illustrated in an expanded position. For installation, the second flange 204 is elastically deformed, or folded in line with the first flange 202 as illustrated in phantom lines, such that terminal ends 210, 212 of the second flange 204 converge to the first flange 202, thereby collapsing the first flange 202 and the second flange 204 to a collapsed position. In the collapsed position of the first flange 202 and the second flange 204, the first flange 202 and the second flange 204 are sized to pass through the aperture 142. After the first flange 202 and the second flange 204 are inserted through the aperture 142, the second flange 204 expands to elastically return to the expanded position, which provides a retention position to engage the second surface 146 and retain the trim cover 34 to the cushion 140.

In contrast to prior paddles that are not folded, the retainer 200 reduces assembly time by providing compactness, and an ease in insertion and installation. The retainer 200 also avoids: rotation, insertion, and straightening, as associated with a full-length paddle. The ease in installation is provided by the compact collapsed size. Further ease is provided in that it is more ergonomic to insert collapsed flanges 202, 204 than a full length, rotated paddle. The retainer 200 also permits attachment of the trim cover 34 to the cushion 140 as a tie-down, without a visible or apparent join, such as a seam, stitching, weld line, or the like.

FIGS. 10 and 11 illustrate a retainer 230 according to another embodiment for utilization with the cushion 140 of the prior embodiments. The retainer 230 includes a flange 232, which may be formed from an extruded polymeric material. The flange 232 may also be formed from a bellyband material strip, an elastic strip, a nonwoven fabric, Duon®, a trim layer material, a barrier layer material, fabric, leather, a polymeric material, such as thermoplastic polyurethane (TPU) film, a polyvinyl chloride (PVC) film, polyethylene, cardboard, an extrusion, or any suitable material.

The flange 232 has a length and a thickness. The flange 232 is elastically deformable along its length. The elastic deformability of the flange 232 is provided by a pair of weakened portions 234. The flange 232 includes a pair of curved recesses 236 formed into the thickness of the flange 232 to reduce the thickness at the weakened portions 234. The curved recesses 236 may be C-shaped or scallop-shaped. The flange 232 is designed with the weakened regions 234 to define the regions for clastic deformation and to act as a living hinge for the flange 232. The pair of curved recesses 236 provide a post 238 formed between the recesses 236. Another recess 240 is formed in the flange 232 in a surface spaced apart from the curved recesses 236 and the post 238. The recess 240 is formed as a notch 240 or a V-shaped groove 240 and is formed centrally and aligned with the post 238. The notch 240 further reduces material thickness of the weakened regions 234, and provides a relief to avoid plastic deformation of the flange 232.

The retainer 230 may include a tether (not shown) attached to the post 238 of the flange 232. The tether may be formed integrally with the flange 232. In some embodiments, the tether is formed from a bellyband material strip, an elastic strip, a nonwoven fabric, Duon®, a trim layer material, a barrier layer material, fabric, leather, polymeric material, such as thermoplastic polyurethane (TPU) film, polyvinyl chloride (PVC) film, polyethylene, cardboard, an extrusion, a thread, a filament, or any suitable material. The tether may be tied, sewn, welded, stitched, blind-stitched, or otherwise fastened to the flange 232. A proximal end of the tether is attached to the flange 232 at the post 238 between the curved recesses 236. A distal end of the tether is attachable to the trim cover 34 directly, or indirectly via an intermediate foundation layer 54 as demonstrated in prior embodiments. The distal end of the tether may be attached directly or may employ a base for the attachments, as in the prior embodiments. The tether is utilized to interconnect the trim cover 34 and the flange 232, while permitting the flange 232 to be spaced apart from the trim cover 34. The tether is sized to be received through the aperture 142 of the cushion 140.

The flange 232 is illustrated in an expanded position. For installation, the flange 232 is elastically deformed, or folded at the weakened regions 234 such that terminal ends of the flange 232 converge, thereby collapsing the flange 232 to a collapsed position. In the collapsed position of the flange 232, the flange 232 is sized to pass through the aperture 142. After the flange 232 is inserted through the aperture 142, the flange 232 expands to elastically return to the expanded position, which provides a retention position to engage the second surface 146 and retain the trim cover 34 to the cushion 140.

In contrast to prior paddles that are not folded, the retainer 230 reduces assembly time by providing compactness, and an ease in insertion and installation. The retainer 230 also avoids: rotation, insertion, and straightening, as associated with a full-length paddle. The ease in installation is provided by the compact collapsed size. Further ease is provided in that it is more ergonomic to insert a folded flange 232 than a full length, rotated paddle. In other words, it is easier to force an arrow than push an askew paddle with a flexible tether. The retainer 230 also permits attachment of the trim cover 34 to the cushion 140 as a tie-down, without a visible or apparent join, such as a seam, stitching, weld line, or the like.

FIGS. 12 and 13 illustrate a retainer 250 for attaching the trim cover 34 to the cushion 140. The retainer 250 includes a flange 252 formed from an extruded polymeric material. The flange 252 may also be formed from a bellyband material strip, an elastic strip, a nonwoven fabric, Duon®, a trim layer material, a barrier layer material, a fabric, leather, a polymeric material, such as thermoplastic polyurethane (TPU) film, a polyvinyl chloride (PVC) film, polyethylene, cardboard, an extrusion, or any suitable material.

The flange 252 has a length and a thickness. The flange 252 is elastically deformable along its length. The elastic deformability of the flange 252 may be provided by a weakened portion 254. The flange 252 may include a recess 256 formed into the thickness of the flange 252 to reduce the thickness at the weakened portion 254. The flange 252 is designed with the weakened region 254 to determine the region for elastic deformation and to act as a living hinge for the flange 252.

The retainer 250 includes a tether (not shown) attached to the flange 252. The tether may be formed integrally with the flange 252. In some embodiments, the tether is formed from a bellyband material strip, an elastic strip, a nonwoven fabric, Duon®, a trim layer material, a barrier layer material, fabric, leather, polymeric material, such as thermoplastic polyurethane (TPU) film, polyvinyl chloride (PVC) film, polyethylene, cardboard, an extrusion, a thread, a filament, or any suitable material. The tether may be tied, sewn, welded, stitched, blind-stitched, or otherwise fastened to the flange 252. A proximal end of the tether is attached to the flange 252 at the weakened section 254 within the recess 256. A distal end of the tether is attachable to the trim cover 34 directly, or indirectly via an intermediate foundation layer 54 as demonstrated in prior embodiments. The distal end may be attached directly or may employ a base for the attachments, as in the prior embodiments. The tether is utilized to interconnect the trim cover 34 and the flange 252, while permitting the flange 252 to be spaced apart from the trim cover 34. The tether is sized to be received through the aperture 142.

The flange 252 is illustrated in an expanded position. During installation, the flange 252 is elastically deformed, or folded at the weakened region 254 such that terminal ends of the flange 252 converge, thereby collapsing the flange 252 to a collapsed position. In the collapsed position of the flange 252, the flange 252 is sized to pass through the aperture 142. After the flange 252 is inserted through the aperture 142, the flange 252 expands to elastically return to the expanded position, which provides a retention position to engage the second surface 146 and retain the trim cover 34 to the cushion 140. The expanded flange 252 strengthens a hold of the trim cover 34 when the flange 252 is in the expanded position. The elastic deformation of the flange 252 permits the flange 252 to return to the expanded position, when unloaded, to hold the shape of the flange 252 to support the tether when a tension load is applied to the tether.

In contrast to prior paddles that are not folded, the retainer 250 reduces assembly time by providing compactness, and an case in insertion and installation. The retainer 250 also avoids: rotation, insertion, and straightening, as associated with a full-length paddle. The case in installation is provided by the compact collapsed size. Further case is provided in that it is more ergonomic to insert a folded flange 252 than a full length, rotated paddle. In other words, it is easier to force an arrow than push an askew paddle with a flexible tether. The retainer 250 also permits attachment of the trim cover 34 to the cushion 140 as a tie-down, without a visible or apparent join, such as a scam, stitching, weld line, or the like.

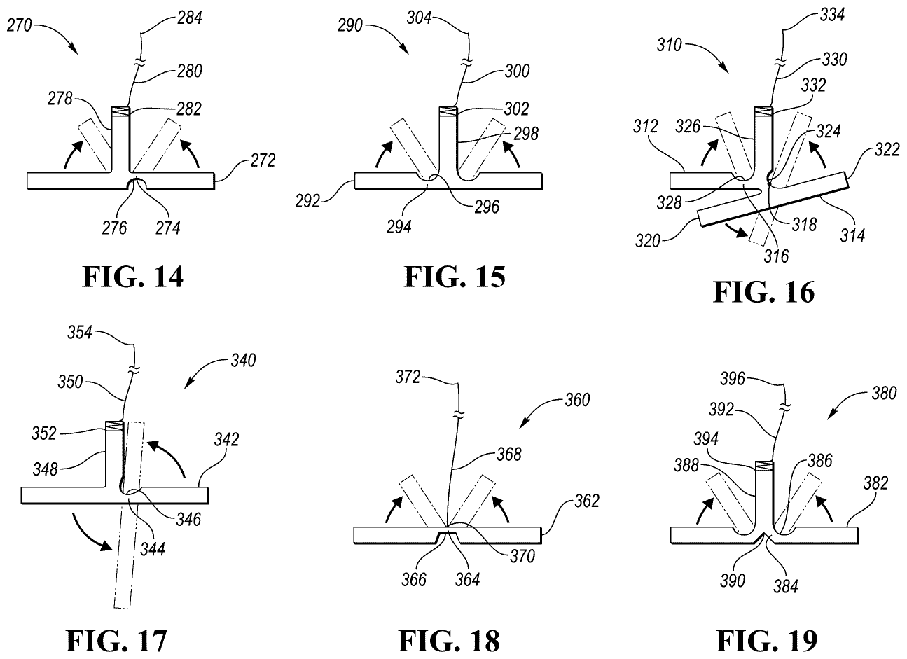

FIG. 14 illustrates a retainer 270 according to another embodiment for utilization with the cushion 140 of the prior embodiments. The retainer 270 includes a flange 272, which may be formed from an extruded polymeric material. The flange 272 may also be formed from a bellyband material strip, an elastic strip, a nonwoven fabric, Duon®, a trim layer material, a barrier layer material, fabric, leather, a polymeric material, such as thermoplastic polyurethane (TPU) film, a polyvinyl chloride (PVC) film, polyethylene, cardboard, an extrusion, or any suitable material.

The flange 272 has a length and a thickness. The flange 272 is elastically deformable along its length. The elastic deformability of the flange 272 is provided by a weakened portion 274. The flange 272 includes a curved recess 276 formed into the thickness of the flange 272 to reduce the thickness at the weakened portion 274. The curved recess 276 may be C-shaped or scallop-shaped. The flange 272 is designed with the weakened region 274 to define the region for clastic deformation and to act as a living hinge for the flange 272. The curved recess 276 is provided in one surface of the flange 272. A post 278 extends from the flange 272 at a surface that is opposed to the recess 276. Additionally, the post 278 is offset from the recess 276 in a length direction of the flange 272.

The retainer 270 includes a tether 280 attached to the post 278. The tether 280 may be formed integrally with the flange 272. In some embodiments, the tether 280 is formed from a bellyband material strip, an elastic strip, a nonwoven fabric, Duon®, a trim layer material, a barrier layer material, fabric, leather, polymeric material, such as thermoplastic polyurethane (TPU) film, polyvinyl chloride (PVC) film, polyethylene, cardboard, an extrusion, a thread, a filament, or any suitable material. The tether 280 may be tied, sewn, welded, stitched, blind-stitched, or otherwise fastened to the post 278. A proximal end 282 of the tether 280 is attached to the flange 272 at the post 278. A distal end 284 of the tether 280 is attachable to the trim cover 34 directly, or indirectly via an intermediate foundation layer 54 as demonstrated in prior embodiments. The distal end 284 may be attached directly or may employ a base for the attachments, as in the prior embodiments. The tether 280 is utilized to interconnect the trim cover 34 and the flange 272, while permitting the flange 272 to be spaced apart from the trim cover 34. The tether 280 is sized to be received through the aperture 142 of the cushion 140.

The flange 272 is illustrated in an expanded position. For installation, the flange 272 is elastically deformed, or folded at the weakened region 274 such that terminal ends of the flange 272 converge to the positions illustrated by phantom lines, thereby collapsing the flange 272 to a collapsed position. In the collapsed position of the flange 272, the flange 272 is sized to pass through the aperture 142. After the flange 272 is inserted through the aperture 142, the flange 272 expands to elastically return to the expanded position, which provides a retention position to engage the second surface 146 and retain the trim cover 34 to the cushion 140.

In contrast to prior paddles that are not folded, the retainer 270 reduces assembly time by providing compactness, and an case in insertion and installation. The retainer 270 also avoids: rotation, insertion, and straightening, as associated with a full-length paddle. The case in installation is provided by the compact collapsed size. Further case is provided in that it is more ergonomic to insert a folded flange 272 than a full length, rotated paddle. In other words, it is easier to force an arrow than push an askew paddle with a flexible tether. The retainer 270 also permits attachment of the trim cover 34 to the cushion 140 as a tie-down, without a visible or apparent join, such as a seam, stitching, weld line, or the like.

FIG. 15 illustrates a retainer 290 according to another embodiment for utilization with the cushion 140 of the prior embodiments. The retainer 290 includes a flange 292, which may be formed from an extruded polymeric material. The flange 292 may also be formed from a bellyband material strip, an elastic strip, a nonwoven fabric, Duon®, a trim layer material, a barrier layer material, fabric, leather, a polymeric material, such as thermoplastic polyurethane (TPU) film, a polyvinyl chloride (PVC) film, polyethylene, cardboard, an extrusion, or any suitable material.

The flange 292 has a length and a thickness. The flange 292 is elastically deformable along its length. The elastic deformability of the flange 292 is provided by a pair of weakened portions 294. The flange 292 includes a pair of curved recesses 296 formed into the thickness of the flange 292 to reduce the thickness at the weakened portions 294. The curved recesses 296 may be C-shaped or scallop-shaped. The flange 292 is designed with the weakened regions 294 to define the regions for elastic deformation and to act as a living hinge for the flange 292. The pair of curved recesses 296 are provided on either side of a post 298 extending from the flange 292 from between the recesses 296.

The retainer 290 includes a tether 300 attached to the post 298. The tether 300 may be formed integrally with the flange 292. In some embodiments, the tether 300 is formed from a bellyband material strip, an elastic strip, a nonwoven fabric, Duon®, a trim layer material, a barrier layer material, fabric, leather, polymeric material, such as thermoplastic polyurethane (TPU) film, polyvinyl chloride (PVC) film, polyethylene, cardboard, an extrusion, a thread, a filament, or any suitable material. The tether 300 may be tied, sewn, welded, stitched, blind-stitched, or otherwise fastened to the post 298. A proximal end 302 of the tether 300 is attached to the flange 292 at the post 298 between the curved recesses 296. A distal end 304 of the tether 300 is attachable to the trim cover 34 directly, or indirectly via an intermediate foundation layer 54 as demonstrated in prior embodiments. The distal end 304 may be attached directly or may employ a base for the attachments, as in the prior embodiments. The tether 300 is utilized to interconnect the trim cover 34 and the flange 292, while permitting the flange 292 to be spaced apart from the trim cover 34. The tether 300 is sized to be received through the aperture 142 of the cushion 140.

The flange 292 is illustrated in an expanded position. For installation, the flange 292 is elastically deformed, or folded at the weakened regions 294 such that terminal ends of the flange 292 converge, thereby collapsing the flange 292 to a collapsed position. In the collapsed position of the flange 292, the flange 292 is sized to pass through the aperture 142. After the flange 292 is inserted through the aperture 142, the flange 292 expands to elastically return to the expanded position, which provides a retention position to engage the second surface 146 and retain the trim cover 34 to the cushion 140.

In contrast to prior paddles that are not folded, the retainer 290 reduces assembly time by providing compactness, and an case in insertion and installation. The retainer 290 also avoids: rotation, insertion, and straightening, as associated with a full-length paddle. The case in installation is provided by the compact collapsed size. Further case is provided in that it is more ergonomic to insert a folded flange 292 than a full length, rotated paddle. In other words, it is easier to force an arrow than push an askew paddle with a flexible tether. The retainer 290 also permits attachment of the trim cover 34 to the cushion 140 as a tie-down, without a visible or apparent join, such as a seam, stitching, weld line, or the like.

FIG. 16 illustrates a retainer 310 according to another embodiment for utilization with the cushion 140 of the prior embodiments. The retainer 310 includes a first flange 312, which may be formed from an extruded polymeric material. The first flange 312 may also be formed from a bellyband material strip, an elastic strip, a nonwoven fabric, Duon®, a trim layer material, a barrier layer material, fabric, leather, a polymeric material, such as thermoplastic polyurethane (TPU) film, a polyvinyl chloride (PVC) film, polyethylene, cardboard, an extrusion, or any suitable material.

The first flange 312 has a length and a thickness. The retainer 310 also has a second flange 314. The second flange 314 may be formed integrally with the first flange 312. The second flange 314 also has a length and a thickness. The second flange 314 is connected to a proximal end 316 of the first flange 312 at a web 318 at a midpoint of the second flange 314. The length of the second flange 314 provides a pair of spaced apart terminal ends 320, 322 that extend away from the first flange proximal end 316. The second flange 314 is slightly angled relative to the first flange 312 and therefore, not parallel with the first flange 312.

The second flange 314 is elastically deformable relative to the first flange 312.

Specifically, the web 318 includes a weakened region with a reduced thickness to determine the elastic deformability of the second flange 314. The elastic deformability of the second flange 314 may be further defined by a recess 324 formed in the web 318. As illustrated by the arrows and phantom lines in FIG. 16, the second flange 314 can be pivoted to collapse such that the terminal end 322 of the second flange 314 converges with the distal end of the first flange 312. A post 326 is connected to the first flange proximal end 316 and the web 318. The recess 324 may be formed into the web 318 and the post 326 so that the second flange 314 is pivotal relative to the post 326. Additionally, another recess 328 may be formed in the first flange 312 at the proximal end 316 to weaken the first flange proximal end 316 for elastic deformation of the first flange 312 relative to the post 326.

The retainer 310 includes a tether 330 attached to the first flange 312 near the first flange proximal end 316. The tether 330 may be formed integrally with the first flange 312. In some embodiments, the tether 330 is formed from a bellyband material strip, an elastic strip, a nonwoven fabric, Duon®, a trim layer material, a barrier layer material, fabric, leather, polymeric material, such as thermoplastic polyurethane (TPU) film, polyvinyl chloride (PVC) film, polyethylene, cardboard, an extrusion, a thread, a filament, or any suitable material. The tether 330 may be tied, sewn, welded, stitched, blind-stitched, or otherwise fastened to the post 326.

A proximal end 332 of the tether 330 is attached to the post 326. A distal end 334 of the tether 330 is attachable to the trim cover 34 directly, or indirectly via an intermediate foundation layer 54 as demonstrated in prior embodiments. The distal end 334 may be attached directly or may employ a base for the attachments, as in the prior embodiments. The tether 330 is utilized to interconnect the trim cover 34 and the post 326, while permitting the first flange 312 and the second flange 314 to be spaced apart from the trim cover 34. The tether 330 is sized to be received through the aperture 142 of the cushion 140.

The first flange 312 and the second flange 314 are illustrated in an expanded position. For installation, the second flange 314 is elastically deformed, or folded so that the second flange terminal end 322 converges with the post 326 as illustrated in phantom lines. The first flange 312 is also elastically deformed, or pivoted to converge with the post 326 as illustrated in phantom lines of the collapsed position. In the collapsed position of the first flange 312 and the second flange 314, the first flange 312 and the second flange 314 are sized to pass through the aperture 142. After the first flange 312 and the second flange 314 are inserted through the aperture 142, the second flange 314 expands to elastically return to the expanded position, which provides a retention position to engage the second surface 146 and retain the trim cover 34 to the cushion 140.

In contrast to prior paddles that are not folded, the retainer 310 reduces assembly time by providing compactness, and an case in insertion and installation. The retainer 310 also avoids: rotation, insertion, and straightening, as associated with a full-length paddle. The case in installation is provided by the compact collapsed size. Further case is provided in that it is more ergonomic to insert collapsed flanges 312, 314 than a full length, rotated paddle. The retainer 310 also permits attachment of the trim cover 34 to the cushion 140 as a tie-down, without a visible or apparent join, such as a scam, stitching, weld line, or the like.

FIG. 17 illustrates a retainer 340 according to another embodiment for utilization with the cushion 140 of the prior embodiments. The retainer 340 includes a flange 342, which may be formed from an extruded polymeric material. The flange 342 may also be formed from a bellyband material strip, an elastic strip, a nonwoven fabric, Duon®, a trim layer material, a barrier layer material, fabric, leather, a polymeric material, such as thermoplastic polyurethane (TPU) film, a polyvinyl chloride (PVC) film, polyethylene, cardboard, an extrusion, or any suitable material.

The flange 342 has a length and a thickness. The flange 342 is elastically deformable along its length. The elastic deformability of the flange 342 is provided by a weakened portion 344. The flange 342 includes a curved recess 346 formed into the thickness of the flange 342 to reduce the thickness at the weakened portion 344. The curved recess 346 may be C-shaped or scallop-shaped. The flange 342 is designed with the weakened region 344 to define the region for clastic deformation and to act as a living hinge for the flange 342. The curved recess 346 is provided in one surface of the flange 342. A post 348 extends from the flange 342 at a surface that is adjacent to the recess 346. Additionally, the post 348 is offset from the recess 346 in a length direction of the flange 342.

The retainer 340 includes a tether 350 attached to the post 348. The tether 350 may be formed integrally with the flange 342. In some embodiments, the tether 350 is formed from a bellyband material strip, an elastic strip, a nonwoven fabric, Duon®, a trim layer material, a barrier layer material, fabric, leather, polymeric material, such as thermoplastic polyurethane (TPU) film, polyvinyl chloride (PVC) film, polyethylene, cardboard, an extrusion, a thread, a filament, or any suitable material. The tether 350 may be tied, sewn, welded, stitched, blind-stitched, or otherwise fastened to the post 348. A proximal end 352 of the tether 350 is attached to the flange 342 at the post 348. A distal end 354 of the tether 350 is attachable to the trim cover 34 directly, or indirectly via an intermediate foundation layer 54 as demonstrated in prior embodiments. The distal end 354 may be attached directly or may employ a base for the attachments, as in the prior embodiments. The tether 350 is utilized to interconnect the trim cover 34 and the flange 342, while permitting the flange 342 to be spaced apart from the trim cover 34. The tether 350 is sized to be received through the aperture 142 of the cushion 140.

The flange 342 is illustrated in an expanded position. For installation, the flange 342 is elastically deformed, or folded at the weakened region 344 such a terminal end of the flange 342 converges toward the post 348 in the position illustrated by phantom lines, thereby collapsing the flange 342 to a collapsed position. In the collapsed position of the flange 342, the flange 342 is sized to pass through the aperture 142. After the flange 342 is inserted through the aperture 142, the flange 342 expands to elastically return to the expanded position, which provides a retention position to engage the second surface 146 and retain the trim cover 34 to the cushion 140.

In contrast to prior paddles that are not folded, the retainer 340 reduces assembly time by providing compactness, and an case in insertion and installation. The retainer 340 also avoids: rotation, insertion, and straightening, as associated with a full-length paddle. The case in installation is provided by the compact collapsed size. Further case is provided in that it is more ergonomic to insert a folded flange 342 than a full length, rotated paddle. In other words, it is easier to force an arrow than push an askew paddle with a flexible tether. The retainer 340 also permits attachment of the trim cover 34 to the cushion 140 as a tie-down, without a visible or apparent join, such as a seam, stitching, weld line, or the like.

FIG. 18 illustrates a retainer 360 for attaching the trim cover 34 to the cushion 140. The retainer 360 includes a flange 362 formed from an extruded polymeric material. The flange 362 may also be formed from a bellyband material strip, an elastic strip, a nonwoven fabric, Duon®, a trim layer material, a barrier layer material, a fabric, leather, a polymeric material, such as thermoplastic polyurethane (TPU) film, a polyvinyl chloride (PVC) film, polyethylene, cardboard, an extrusion, or any suitable material. The flange 362 may be referred to as a paddle 362.

The flange 362 has a length and a thickness. The flange 362 is elastically deformable along its length. The elastic deformability of the flange 362 may be provided by a weakened portion 364. The flange 362 may include a recess 366 formed into the thickness of the flange 362 to reduce the thickness at the weakened portion 364. The flange 362 is designed with the weakened region 364 to determine the region for elastic deformation and to act as a living hinge for the flange 362.

The retainer 360 includes a tether 368 attached to the flange 362. The tether 368 may be formed integrally with the flange 362. In some embodiments, the tether 368 is formed from a bellyband material strip, an elastic strip, a nonwoven fabric, Duon®, a trim layer material, a barrier layer material, fabric, leather, polymeric material, such as thermoplastic polyurethane (TPU) film, polyvinyl chloride (PVC) film, polyethylene, cardboard, an extrusion, a thread, a filament, or any suitable material. The tether 368 may be tied, sewn, welded, stitched, blind-stitched, or otherwise fastened to the flange 362. A proximal end 370 of the tether 368 is attached to the flange 362 at the weakened section 364 opposed from the recess 366. A distal end 372 of the tether 368 is attachable to the trim cover 34 directly, or indirectly via an intermediate foundation layer 54 as demonstrated in prior embodiments. The distal end 372 may be attached directly or may employ a base for the attachments, as in the prior embodiments. The tether 368 is utilized to interconnect the trim cover 34 and the flange 362, while permitting the flange 362 to be spaced apart from the trim cover 34. The tether 368 is sized to be received through the aperture 142.

The flange 362 is illustrated in an expanded position. For installation, the flange 362 is elastically deformed, or folded at the weakened region 364 such that terminal ends of the flange 362 converge, thereby collapsing the flange 362 to a collapsed position illustrated in phantom lines. In the collapsed position of the flange 362, the flange 362 is sized to pass through the aperture 142. After the flange 362 is inserted through the aperture 142, the flange 362 expands to elastically return to the expanded position, which provides a retention position to engage the second surface 146 and retain the trim cover 34 to the cushion 140. The expanded flange 362 strengthens a hold of the trim cover 34 when the flange 362 is in the expanded position. The elastic deformation of the flange 362 permits the flange 362 to return to the expanded position, when unloaded, to hold the shape of the flange 362 to support the tether 368 when a tension load is applied to the tether 368.

In contrast to prior paddles that are not folded, the retainer 360 reduces assembly time by providing compactness, and an case in insertion and installation. The retainer 360 also avoids: rotation, insertion, and straightening, as associated with a full-length paddle. The case in installation is provided by the compact collapsed size. Further case is provided in that it is more ergonomic to insert a folded flange 362 than a full length, rotated paddle. In other words, it is easier to force an arrow than push an askew paddle with a flexible tether. The retainer 360 also permits attachment of the trim cover 34 to the cushion 140 as a tie-down, without a visible or apparent join, such as a scam, stitching, weld line, or the like.

FIG. 19 illustrates a retainer 380 according to another embodiment for utilization with the cushion 140 of the prior embodiments. The retainer 380 includes a flange 382, which may be formed from an extruded polymeric material. The flange 382 may also be formed from a bellyband material strip, an elastic strip, a nonwoven fabric, Duon®, a trim layer material, a barrier layer material, fabric, leather, a polymeric material, such as thermoplastic polyurethane (TPU) film, a polyvinyl chloride (PVC) film, polyethylene, cardboard, an extrusion, or any suitable material.

The flange 382 has a length and a thickness. The flange 382 is elastically deformable along its length. The clastic deformability of the flange 382 is provided by a pair of weakened portions 384. The flange 382 includes a pair of curved recesses 386 formed into the thickness of the flange 382 to reduce the thickness at the weakened portions 384. The curved recesses 386 may be C-shaped or scallop-shaped. The flange 382 is designed with the weakened regions 384 to define the regions for elastic deformation and to act as a living hinge for the flange 382. The pair of curved recesses 386 are provide on opposed adjacent intersections with a post 388 extending from the flange 382 between the recesses 386. Another recess 390 is formed in the flange 382 in a surface spaced apart from the curved recesses 386 and the post 388. The recess 390 is formed as a notch 390 or a V-shaped groove 390 and is formed centrally and aligned with the post 388. The notch 390 further reduces material thickness of the weakened regions 384, and provides a relief to avoid plastic deformation of the flange 382.

The retainer 380 includes a tether 392 attached to the post 388 of the flange 382. The tether 392 may be formed integrally with the flange 382. In some embodiments, the tether 392 is formed from a bellyband material strip, an elastic strip, a nonwoven fabric, Duon®, a trim layer material, a barrier layer material, fabric, leather, polymeric material, such as thermoplastic polyurethane (TPU) film, polyvinyl chloride (PVC) film, polyethylene, cardboard, an extrusion, a thread, a filament, or any suitable material. The tether 392 may be tied, sewn, welded, stitched, blind-stitched, or otherwise fastened to the flange 382. A proximal end 394 of the tether 392 is attached to the flange 382 at the post 388 between the curved recesses 386. A distal end 396 of the tether 392 is attachable to the trim cover 34 directly, or indirectly via an intermediate foundation layer 54 as demonstrated in prior embodiments. The distal end 396 may be attached directly or may employ a base for the attachments, as in the prior embodiments. The tether 392 is utilized to interconnect the trim cover 34 and the flange 382, while permitting the flange 382 to be spaced apart from the trim cover 34. The tether 392 is sized to be received through the aperture 142 of the cushion 140.

The flange 382 is illustrated in an expanded position. For installation, the flange 382 is elastically deformed, or folded at the weakened regions 384 such that terminal ends of the flange 382 converge, thereby collapsing the flange 382 to a collapsed position illustrated in phantom in FIG. 19. In the collapsed position of the flange 382, the flange 382 is sized to pass through the aperture 142. After the flange 382 is inserted through the aperture 142, the flange 382 expands to elastically return to the expanded position, which provides a retention position to engage the second surface 146 and retain the trim cover 34 to the cushion 140.

In contrast to prior paddles that are not folded, the retainer 380 reduces assembly time by providing compactness, and an ease in insertion and installation. The retainer 380 also avoids: rotation, insertion, and straightening, as associated with a full-length paddle. The ease in installation is provided by the compact collapsed size. Further ease is provided in that it is more ergonomic to insert a folded flange 382 than a full length, rotated paddle. In other words, it is easier to force an arrow than push an askew paddle with a flexible tether. The retainer 380 also permits attachment of the trim cover 34 to the cushion 140 as a tie-down, without a visible or apparent join, such as a seam, stitching, weld line, or the like.

According to a first clause, a cushion assembly is provided alone, or in combination with any of the succeeding clauses, with a cushion, that is provided with a mesh member. The mesh member is provided with a set of filaments of polymeric material. At least two members of the set of filaments are looped and bonded to each other. The cushion is further provided with an occupant support surface. An aperture is formed through the cushion. A trim member is sized to extend at least partially across the occupant support surface of the cushion. A retainer is provided with a base connected to the trim member. A tether extends from the base and is sized to be received in the aperture formed through the cushion. A flange is attached to the tether, spaced apart from the base, and sized to be inserted through the aperture. A fastener is attached to the flange.

According to a second clause, the cushion assembly of any of the preceding or successive clauses is provided, wherein the fastener is sized to be inserted through the cushion aperture.

According to a third clause, the cushion assembly of any of the preceding or successive clauses is provided, wherein the aperture formed through the cushion is further defined as a first aperture. The retainer is further defined as a first retainer. A second aperture is formed through the cushion. The cushion assembly is further provided with a second retainer. The second retainer is further provided with a base connected to the trim member. A tether extends from the base of the second retainer and sized to be received in the second aperture formed through the cushion.

According to a fourth clause, the cushion assembly of any of the preceding or successive clauses is provided, wherein the flange of the first retainer extends toward the second aperture. The second retainer is further provided with a flange extending toward the first aperture.

According to a fifth clause, the cushion assembly of any of the preceding or successive clauses is provided, wherein the fastener is further defined as a first fastener. The cushion assembly is further provided with a second fastener attached to the flange of the second retainer and fastened to the first fastener.

According to a sixth clause, the cushion assembly of any of the preceding or successive clauses is provided, wherein the trim member is provided with an external surface and a concealed surface, wherein the base of the retainer is connected to the concealed surface.

According to a seventh clause, the cushion assembly of any of the preceding or successive clauses is provided, wherein the trim member is further provided with a trim layer and a foundation layer.

According to an eighth clause, the cushion assembly of any of the preceding or successive clauses is provided, wherein base of the retainer is attached to the trim member without an externally visible join.

According to a ninth clause, a seat assembly is provided with a seat frame. The cushion assembly of any of the preceding or successive clauses is provided, wherein the cushion is attached to the seat frame, and wherein the trim member is sized to at least partially conceal the cushion.

According to a tenth clause, a cushion assembly is provided alone, or in combination with any of the preceding and successive clauses, with a cushion. The cushion is further provided with an occupant support surface. An aperture is formed through the cushion. A trim member is sized to extend at least partially across the occupant support surface of the cushion. A retainer is provided with a tether extending from the trim member and sized to be received in the aperture in the cushion. A flange is attached to the tether, spaced apart from the trim member. At least a portion of the flange is elastically deformable relative to the tether so that the flange is collapsible and insertable through the aperture, and expandable to retain the retainer.

According to an eleventh clause, the cushion assembly of any of the preceding or successive clauses is provided, wherein the flange defines a weakened portion for elastic deformation of the flange at the weakened portion.

According to a twelfth clause, the cushion assembly of any of the preceding or successive clauses is provided, wherein a recess is formed in the flange to provide the weakened portion.

According to a thirteenth clause, the cushion assembly of any of the preceding or successive clauses is provided, wherein the retainer is further provided with a post extending from the flange to connect the flange to the tether.

According to a fourteenth clause, the cushion assembly of any of the preceding or successive clauses is provided, wherein a recess is formed in a surface of the flange that is spaced apart from the post to define a region for elastic deformation of the flange.

According to a fifteenth clause, the cushion assembly of any of the preceding or successive clauses is provided, wherein a pair of spaced apart recesses are formed in the flange with the post therebetween to define regions for elastic deformation of the flange.

According to a sixteenth clause, the cushion assembly of any of the preceding or successive clauses is provided, wherein the post and the flange are formed integrally.

According to a seventeenth clause, the cushion assembly of any of the preceding or successive clauses is provided, wherein the post and the flange is further provided from a polymeric material.

According to an eighteenth clause, the cushion assembly of any of the preceding or successive clauses is provided, wherein the tether is provided from a polymeric material.

According to a nineteenth clause, the cushion assembly of any of the preceding or successive clauses is provided, wherein the retainer is further provided with a second flange angled relative to the first flange.

According to a twentieth clause, the cushion assembly of any of the preceding or successive clauses is provided, wherein a weakened region is formed in one of the first flange and the second flange to provide a pivotal connection.

According to a twenty-first clause, the cushion assembly of any of the preceding or successive clauses is provided, wherein the retainer is further provided with a living hinge connecting the flange to the tether.

According to a twenty-second clause, a cushion assembly is provided alone, or in combination with any of the preceding or successive clauses, with a cushion. The cushion is further provided with an occupant support surface, and wherein an aperture is formed through the cushion. A trim member is sized to extend at least partially across the occupant support surface of the cushion. A retainer is provided with a tether extending from the trim member and sized to be received in the aperture in the cushion. A flange is attached to the tether, spaced apart from the trim member, wherein the flange is further provided with a weakened portion so that the flange is collapsible and insertable through the aperture, and expandable to retain the retainer.

According to a twenty-third clause, the cushion assembly of any of the preceding or successive clauses is provided, wherein the cushion is further provided with a mesh member. The mesh member is further provided with a set of filaments of polymeric material, wherein at least two members of the set of filaments are looped and bonded to each other.

According to a twenty-fourth clause, the cushion assembly of any of the preceding or successive clauses is provided, wherein the retainer is attached to the trim member without an externally visible join.

According to a twenty-fifth clause, a method of installing the cushion assembly of any of the preceding or successive clauses, elastically deforms the flange. The flange and the tether are inserted through the aperture formed through the cushion until the flange expands, thereby attaching the trim member to the cushion.

According to a twenty-sixth clause, a seat assembly is provided with a seat frame and the cushion assembly of any of the preceding clauses, wherein the cushion is attached to the seat frame, and wherein the trim member is sized to at least partially conceal the cushion and the seat frame.

While various embodiments are described above, it is not intended that these embodiments describe all possible forms according to the disclosure. In that regard, the words used in the specification are words of description rather than limitation, and it is understood that various changes may be made without departing from the spirit and scope of the disclosure. Additionally, the features of various implementing embodiments may be combined to form further embodiments according to the disclosure.

1. A cushion assembly comprising:
a cushion, that comprises a mesh member, the mesh member comprising a set of filaments of polymeric material, wherein at least two members of the set of filaments are looped and bonded to each other, wherein the cushion further comprises an occupant support surface, and wherein an aperture is formed through the cushion;
a trim member sized to extend at least partially across the occupant support surface of the cushion;
a retainer comprising:
a base connected to the trim member,
a tether extending from the base and sized to be received in the aperture formed through the cushion, and
a flange attached to the tether, spaced apart from the base, and sized to be inserted through the aperture; and
a fastener attached to the flange.

2. (canceled)

3. The cushion assembly of claim 1, wherein the aperture formed through the cushion is further defined as a first aperture;
wherein the retainer is further defined as a first retainer;
wherein a second aperture is formed through the cushion; and
wherein the cushion assembly further comprises a second retainer comprising:
a base connected to the trim member, and
a tether extending from the base of the second retainer and sized to be received in the second aperture formed through the cushion.

4. The cushion assembly of claim 3, wherein the flange of the first retainer extends toward the second aperture; and
wherein the second retainer comprises a flange extending toward the first aperture.

5. The cushion assembly of claim 4, wherein the fastener is further defined as a first fastener; and
wherein the cushion assembly further comprises a second fastener attached to the flange of the second retainer and fastened to the first fastener.

6. The cushion assembly of claim 1, wherein the trim member comprises an external surface and a concealed surface, wherein the base of the retainer is connected to the concealed surface.

7. (canceled)

8. The cushion assembly of claim 1, wherein base of the retainer is attached to the trim member without an externally visible join.

9. A seat assembly comprising:
a seat frame; and
the cushion assembly of claim 1, wherein the cushion is attached to the seat frame, and wherein the trim member is sized to at least partially conceal the cushion.

10. A cushion assembly comprising:
a cushion, wherein the cushion further comprises an occupant support surface, and wherein an aperture is formed through the cushion;
a trim member sized to extend at least partially across the occupant support surface of the cushion; and
a retainer comprising:
a tether extending from the trim member and sized to be received in the aperture in the cushion, and
a flange attached to the tether, spaced apart from the trim member, wherein at least a portion of the flange is elastically deformable relative to the tether so that the flange is collapsible and insertable through the aperture, and expandable to retain the retainer.

11. The cushion assembly of claim 10, wherein the flange defines a weakened portion for elastic deformation of the flange at the weakened portion.

12. The cushion assembly of claim 11, wherein a recess is formed in the flange to provide the weakened portion.

13. The cushion assembly of claim 10, wherein the retainer further comprises a post extending from the flange to connect the flange to the tether.

14. The cushion assembly of claim 13, wherein a recess is formed in a surface of the flange that is spaced apart from the post to define a region for elastic deformation of the flange.

15. The cushion assembly of claim 13, wherein a pair of spaced apart recesses are formed in the flange with the post therebetween to define regions for elastic deformation of the flange.

16-18. (canceled)

19. The cushion assembly of claim 10, wherein the retainer further comprises a second flange angled relative to the first flange.

20. The cushion assembly of claim 19, wherein a weakened region is formed in one of the first flange and the second flange to provide a pivotal connection.

21. The cushion assembly of claim 10, wherein the retainer further comprises a living hinge connecting the flange to the tether.

22. A cushion assembly comprising:
a cushion, wherein the cushion further comprises an occupant support surface, and wherein an aperture is formed through the cushion;
a trim member sized to extend at least partially across the occupant support surface of the cushion; and
a retainer comprising:
a tether extending from the trim member and sized to be received in the aperture in the cushion, and
a flange attached to the tether, spaced apart from the trim member, wherein the flange comprises a weakened portion so that the flange is collapsible and insertable through the aperture, and expandable to retain the retainer.

23. (canceled)

24. The cushion assembly of claim 10, wherein the retainer is attached to the trim member without an externally visible join.

25. A method of installing the cushion assembly of claim 10, the method comprising:
elastically deforming the flange; and
inserting the flange and the tether through the aperture formed through the cushion until the flange expands, thereby attaching the trim member to the cushion.

26. A seat assembly comprising:
a seat frame; and
the cushion assembly of claim 10, wherein the cushion is attached to the seat frame, and wherein the trim member is sized to at least partially conceal the cushion and the seat frame.
